(19) United States
(12) Patent Application Publication
(10) Pub. No.: US 2016/0188086 A1
(43) Pub. Date: Jun. 30, 2016

(54) DYNAMIC TACTILE INTERFACE

(71) Applicant: Tactus Technology, Inc., Fremont, CA (US)

(72) Inventor: Micah Yairi, Fremont, CA (US)

(21) Appl. No.: 14/843,583

(22) Filed: Sep. 2, 2015

Related U.S. Application Data
(60) Provisional application No. 62/044,808, filed on Sep. 2, 2014.

(51) Int. Cl. G06F 3/041; G06F 3/01; G06F 3/044

(52) U.S. Cl. CPC G06F 3/0416; G06F 3/0414; G06F 3/0412; G06F 3/044; G06F 3/016

(57) ABSTRACT

A dynamic tactile interface includes: a substrate, a tactile layer, and movable support member. The substrate defines a fluid channel and a perforation coupled to the fluid channel. The tactile layer includes a first region and a deformable region, the first region coupled to the substrate, and the deformable region arranged over and coupled to a moveable support member, which is disconnected from the substrate, substantially corresponds to the perforation, and is coupled to the fluid channel, the deformable region operable between an expanded setting and a depressed setting. The movable support layer traveling within the cavity with the deformable region, the deformbable region substantially flush with the first region in the expanded setting and below the first region in the depressed setting.

### CROSS-REFERENCE TO RELATED APPLICATIONS

The application claims the benefit of U.S. Provisional Patent Application No. 62/044,808, filed on 2 Sep. 2014, which is incorporated in its entirety by this reference.

This application is related to U.S. Provisional Patent Application No. 61/907,534, filed on 22 Nov. 2013; U.S. patent application Ser. No. 11/969,848, filed on 4 Jan. 2008; U.S. patent application Ser. No. 13/414,589 filed 7 Mar. 2012; U.S. patent application Ser. No. 13/456,010, filed 25 Apr. 2012; U.S. patent application Ser. No. 13/456,031, filed 25 Apr. 2012; U.S. patent application Ser. No. 13/465,737, filed 7 May 2012; and U.S. patent application Ser. No. 13/465,772, filed 7 May 2012, all of which are incorporated in their entireties by this reference.

### TECHNICAL FIELD

This invention relates generally to touch-sensitive displays, and more specifically to a new and useful dynamic tactile interface in the field of touch-sensitive displays.

### BRIEF DESCRIPTION OF THE FIGURES

FIG. 1A is schematic representations of a dynamic tactile interface;

FIG. 1B is a schematic representation of a dynamic tactile interface.

FIG. 2 is schematic representation of the dynamic tactile interface;

FIG. 3 is a flowchart representation of a variation of the dynamic tactile interface;

FIG. 4 is a schematic of one variation of the dynamic tactile interface; and

FIG. 5 is a flowchart representation of a variation of the dynamic tactile interface;

FIG. 6 is a flowchart representation of one variation of the dynamic tactile interface; and

FIG. 7 is a flowchart representation of one variation of the dynamic tactile interface.

FIG. 8 is a flowchart representation of one variation of the dynamic tactile interface.

FIG. 9 is a flowchart representation of one variation of the dynamic tactile interface.

### DESCRIPTION OF THE EMBODIMENTS

The following description of the embodiment of the invention is not intended to limit the invention to these embodiments, but rather to enable any person skilled in the art to make and use this invention.

### 1. Dynamic Tactile Interface

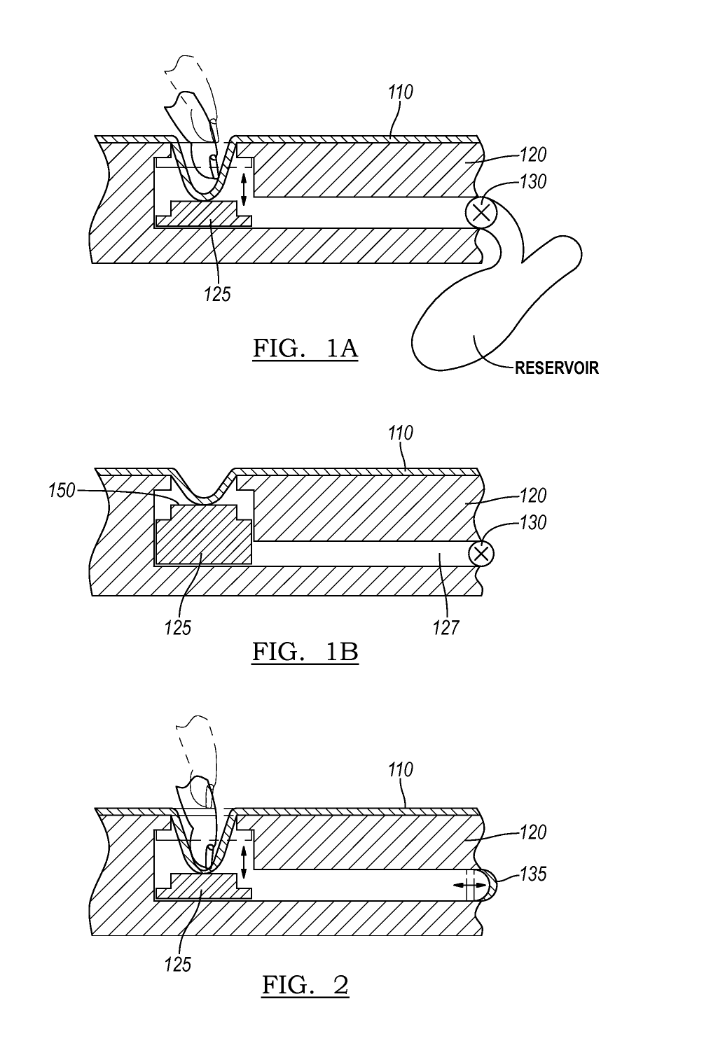

As shown in FIG. 1A, a dynamic tactile interface includes: a substrate 120, a tactile layer 110, and a fluid regulator 130. The substrate 120 defines a fluid channel and a perforation coupled to the fluid channel. The tactile layer no includes a first region and a deformable region, the first region coupled to the substrate 120, and the deformable region arranged over and coupled to a moveable support member 125, which is disconnected from the substrate 120, substantially corresponds to the perforation, and is coupled to the fluid channel, the deformable region operable between an expanded setting and a depressed setting, the deformable region substantially flush with the first region in the expanded setting and substantially below the first region (i.e., depressed toward the substrate 120) in the depressed setting. The fluid regulator 130 is fluidly coupled to the fluid channel and displaces fluid to and from the fluid channel in order to transition the deformable region between the expanded setting and the depressed setting.

Generally, the dynamic tactile interface functions as an interface for an electronic device to provide intermittent tactile feedback to a user for an input at an input region on the device. The dynamic tactile interface further functions as a reconfigurable (i.e., refreshable) input surface with deformable input regions that transition between flush (i.e., expanded) and depressed settings and captures user inputs on the deformable region during use of a connected computing device. The dynamic tactile interface can be integrated within a hard case for a mobile computing device (e.g., a smartphone or a tablet) with the substrate 120 and tactile layer 110 applied over a touchscreen of the device to provide tactile guidance to a user as the user provides inputs into the device via the touchscreen. In one implementation, the deformable region can be planar or flush with the first region in the expanded setting and dips below the first region (i.e., toward the substrate 120) in the depressed setting to define a tactilely distinguishable feature on the tactile surface. In this implementation, the deformable region can coincide with (i.e., be arranged over) an input key rendered on a touchscreen of the device such that, in the expanded setting, the deformable region mimics a flush surface of the tablet displaying an image of an input key and, in the depressed setting, the deformable region mimics a depressed (i.e., concave or recessed) key, thus tactilely guiding and verifying selection of the corresponding rendered input key by the user. The deformable region can be expanded to yield a flush, smooth, and/or continuous surface and substantially minimal optical distortion across the deformable and first regions. The fluid regulator 130 (e.g., a valve, pump, etc.) regulates fluid flow into and out of the fluid channel, thereby intermittently transitioning the deformable region between the depressed setting and the expanded setting. The fluid regulator 130 can actively manipulate or passively pump or release fluid between a fluid reservoir, which is fluidly coupled to the fluid channel, and the fluid regulator 130. The moveable support member 125 functions as a supporting member when the deformable region is in the expanded setting. The moveable support member 125 can yield a substantially flush exposed surface of the tactile layer no by occupying the area corresponding to the perforation in the expanded setting, thereby supporting the tactile layer 110 so that the deformable region of the tactile layer no is flush with the first region. Thus, the user may not notice the perforation when interacting with the tactile layer no in the expanded setting. In the depressed setting, the moveable support member 125 functions as a tactile support, substantially preventing depression of the deformable region beyond a specified depth below the first region.

As shown in FIG. 1B, the movable support member 125 may have one or more features that provide for and/or guide vertical motion within the substrate. The moveable support member 125 may include vertical sides or surfaces that cooperate with vertical sides or surfaces of a cavity within substrate to allow the member to travel in a vertical motion within substrate 120. In implementations, the vertical support member has vertical sides that extend a vertical distance that is greater that the opening of the fluid channel 127 in a sidewall of a cavity within the substrate. The vertical support member can also be longer than the throw (displacement) of the button to ensure smooth and constrained motion over the duration and length of the button press. In some instances, the vertical support member has a base that is wider than the opening of a fluid channel located at a bottom surface of the cavity within the substrate. When, for example, the vertical support member has vertical sides that have a vertical distance that is greater than the height of the fluid channel 127, the vertical sides of the vertical support member, when the tactile layer is in a depressed setting, may extend above fluid channel and rest against a vertical side of the substrate. In this position, the vertical side of the substrate may cooperate with the vertical side of the movable support member to prevent the movable support member from moving in a horizontal direction. Thus, a portion of the movable support member is in contact or otherwise prevented from moving horizontally by the cavity wall. When the tactile layer is in the expanded setting, the movable support member may be raised within the substrate to a point where the upper surface 150 of the movable support member is flush with the upper surface of the substrate, and the vertical sides of the movable support member will also be in cooperation with vertical sides of the substrate. Thus, whether the tactile layer is in the expanded setting where the upper surface of the movable support member is flush with the upper surface of the substrate or the tactile layer is in the depressed setting and the upper surface 150 of the movable support member is lower than the upper surface of the substrate, the vertical walls of the substrate will prevent horizontal movement by the movable support member, and the movable support member will only be allowed to travel in a vertical direction. As shown in FIGS. 1A and 2-9, the movable support member may be implemented with vertical walls that cooperate with the vertical walls of the substrate to prevent horizontal movement of the movable support member within the substrate. In some instances, the motion restriction is a one-dimensional restriction and can be used to provide controlled diagonal movement of the deformable region when the deformable region is depressed.

In various examples, the dynamic tactile interface can be integrated into a case, peripheral, or aftermarket peripheral for a tablet, a smartphone, a laptop computer, a desktop computer, a personal data assistant (PDA), a personal music player (e.g., MP3 player), or other computing device. The dynamic tactile interface can also be incorporated into or arranged over an existing automotive dashboard display or console, a television, a personal navigation device, a watch, a home stereo system interface, a lighting or thermostat control system, a machine tool controller, a computer mouse, a computer touchpad, a keyboard or keypad, a gaming controller or console, cooking equipment, or any other suitable electronic and/or digital computing device.

### 2. Applications

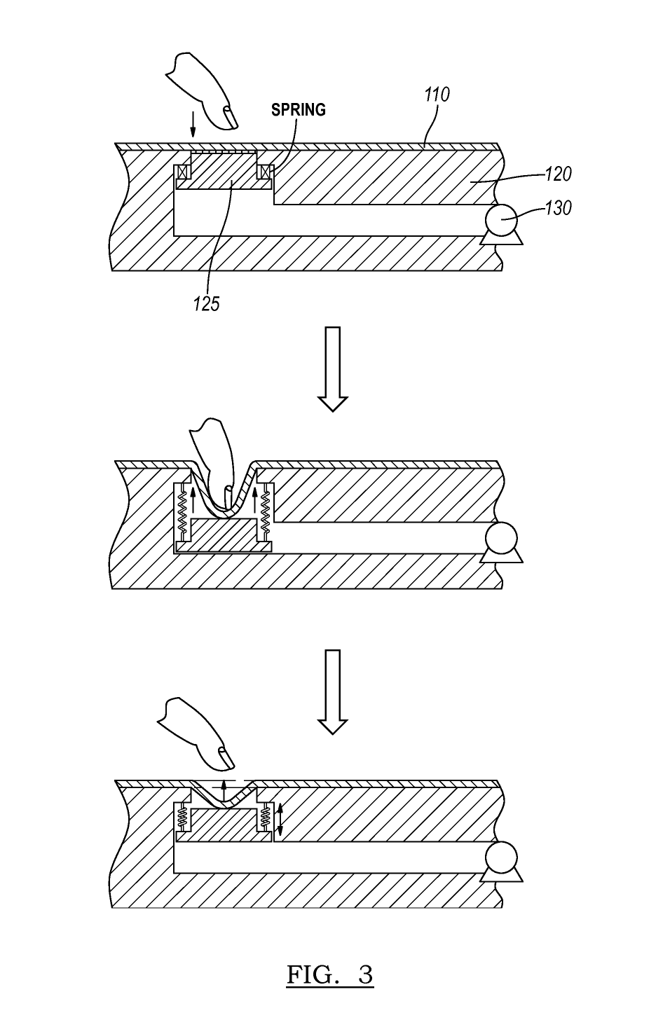

In one example application shown in FIG. 2, the dynamic tactile interface is integrated into tablet including a touch-sensitive display (e.g., touchscreen). The tactile layer 110 is arranged over the display and is substantially transparent and of a refractive index such that the tactile layer 110 does not substantially reflect, refract, or alter the light emitted from the touch-sensitive display and transmitted through the tactile layer no. The tactile layer 110 also defines multiple deformable regions in a keyboard layout. The deformable regions are fluidly coupled to the fluid regulator 130, which includes an expandable volume (e.g., a balloon) that expands and contracts to accommodate displaced fluid as fluid is displaced during the deformation of the deformable regions. In the expanded setting, the expandable volume is configured to have a specified initial volume, and the fluid in the fluid channel and the expandable volume is substantially inert. Furthermore, in the expanded setting, the moveable support member 125 in a first position supports the tactile layer 110 such that a tactile surface of the tactile layer 110 at the deformable region is substantially flush with the tactile surface of the tactile layer no at the first region. As a user depresses the deformable region, the user applies a force that drives the deformable region to the depressed setting. In the depressed setting, the deformable region displaces the moveable support member 125 into the fluid channel. Thus, the expandable volume, which includes an elastic membrane 135, resists the expansion of the expandable volume, displacement of fluid, and, therefore, the depression of the deformable region. However, the elastic membrane 135 of the expandable volume accommodates displacement of fluid by expanding the elastic membrane 135 from an initial state to a final state. When the user removes the pressure applied the tactile surface to depress the deformable region, tension in the elastic membrane 135 causes the elastic membrane 135 to return to the initial state, thereby displacing fluid back into the fluid channel and causing the deformable region to return to the expanded setting and the moveable support member 125 to return to the first position.

In another example application, the dynamic tactile interface is integrated into an aftermarket housing (e.g., a protective case) for a mobile phone with a touch-sensitive display. The dynamic tactile interface is arranged over the display and is substantially transparent and of a refractive index such that the dynamic tactile interface does not substantially reflect, refract, or alter the light emitted from the touch-sensitive display and transmitted through the tactile layer no. The tactile layer 110 also defines multiple deformable regions in a keyboard layout with the keys of the keyboard corresponding to images of input keys displayed on the touch-sensitive display of the mobile phone. An adhesive layer bonds the substantially transparent substrate 120 to the touch-sensitive display. The substrate 120 includes fluid channels fluidly coupling the fluid regulator 130 to the deformable region(s) such that fluid within the fluid channel can travel within the fluid channel to and from the fluid regulator 130 in order to transition the deformable region between the depressed setting and the expanded setting. The fluid regulator 130 includes a pump that selectively pumps fluid from a fluid reservoir in order to expand the deformable region(s) from the depressed setting. Additionally, the substrate 120 defines the perforation (e.g., a bore or a hole in the substrate) coupling the fluid channel to the deformable region so that the moveable support member 125 can translate within the perforation. The moveable support member 125 is bonded to a surface of the tactile layer 110 at a location corresponding to the deformable region and bonded to a surface of the tactile layer 110 opposite the tactile surface. The moveable support member 125 further includes a magnet coupled to a shoulder of the moveable support member 125. The shoulder matches a shoulder of the substrate 120 such that in the expanded setting, the moveable support member 125 supports the tactile layer no so that the tactile layer 110 at the deformable region is substantially flush with the first region. The shoulder of the moveable support member 125 and the shoulder of the substrate 120 further substantially prevent movement of the moveable support member 125 such that the deformable region of tactile layer 110 can be expanded above the first region. The magnet on the shoulder of the moveable support member 125 couples to an attractive magnet on the shoulder of the substrate 120, such that polarity of the magnets substantially support the moveable support member 125 and, therefore, support the tactile layer 110 in the expanded setting. When a user applies a pressure to the deformable region, the pressure can overcome attractive magnetic forces between the magnets and allow the moveable support member 125 and tactile layer 110 to deform into the perforation and thus into the depressed setting. As the tactile layer 110 deforms under pressure applied by the user, the moveable support member 125 translates within the perforation. An additional magnet located on a face of the moveable support member 125 adjacent the fluid channel can be magnetically coupled and attracted to a fluid channel magnet located at the bottom of the fluid channel. Magnetic attraction between the additional magnet and the fluid channel magnet aids deformation of the deformable region into the depressed setting and maintains the depressed setting after the user removes pressure from the deformable region. Translation of the moveable support member 125 and the tactile layer no to the depressed setting (e.g., depressing the tactile layer no) results in decreased volume of the fluid channel and, therefore, displacement of the fluid from the fluid channel. The fluid regulator 130, a pump, passively allows fluid to flow from the fluid channel into a fluid reservoir coupled to the fluid channel and the pump. In order to expand the deformable region to the expanded state, the pump can pump fluid into the chamber, thereby increasing the pressure in the fluid chamber. When pressure within the fluid channel is sufficient to overcome attractive forces between the additional magnet and the fluid channel magnet, the deformable region expands to the expanded setting, further aided by attractive forces between the magnet on the moveable support member 125 and the magnet on the substrate 120.

In another example application, the dynamic tactile interface is integrated into a peripheral device, such as a peripheral, standalone keyboard for a computing device. In this example, the tactile layer no is substantially opaque and defines multiple deformable regions in a keyboard layout and fluidly coupled to the displacement device via one or more fluid channels, wherein each deformable region corresponds to one alphanumeric, symbolic, and/or punctuation characters.

### 3. Tactile Layer

The tactile layer 110 of the dynamic tactile interface includes a first region coupled to the substrate 120, a deformable region adjacent the first region and arranged over the perforation, and a tactile surface opposite the substrate 120. Generally, the tactile layer 110 functions to define one or more deformable regions arranged over a corresponding perforation, such that displacement of fluid into and out of the fluid perforations (i.e., via the fluid channel) causes the deformable region(s) to expand into the expanded setting and to retract into the depressed setting. Thus, the tactile layer no yields a flush surface in the expanded setting and a tactilely distinguishable surface in the depressed setting. The tactile layer no is attached to the substrate 120 across the first region and/or along a periphery of the first region and adjacent or around the deformable region. The tactile layer can be bonded to the substrate at all points across the first region or can be bonded at an area adjacent the deformable region. For example, the tactile layer can be bonded to the substrate at any or all points circumferentially surrounding the deformable region with a circular periphery. Alternatively, a portion of the tactile layer can be bonded to the substrate along the periphery of the deformable region. For example, the tactile layer can be bonded to the substrate along one side of the deformable region with a substantially rectangular periphery. Three remaining sides of the rectangular periphery can be unbounded from the substrate. The deformable region can be substantially flush with the first region in the expanded setting and depressed below the first region (e.g., into the perforation) in the depressed setting, or the deformable region can be arranged at a position offset vertically below the first region in the depressed setting.

In one application in which the dynamic tactile interface is integrated or transiently arranged over a display and/or a touchscreen, the tactile layer 110 can be substantially transparent. For example, the tactile layer 110 can include one or more layers of a urethane, polyurethane, silicone, and/or another transparent material and can be bonded to the substrate 120 of polycarbonate, acrylic, urethane, PET, glass, and/or silicone, such as described in U.S. patent application Ser. No. 14/035,851. Alternatively, the dynamic tactile interface can be arranged in a peripheral device without a display or remote from a display within a device. Thus, the tactile layer 110 can be substantially opaque. For example, the substrate 120 can include one or more layers of colored opaque silicone adhered to a substrate 120 of aluminum.

### 4. Substrate

The substrate 120 of the dynamic tactile interface defines a fluid channel and a perforation fluidly coupled to the fluid channel. Generally, the substrate 120 functions to define a fluid circuit among the fluid regulator 130, the fluid channel, and the perforation and to support and retain the first region of the tactile layer 110, such as described in U.S. patent application Ser. No. 14/035,851, filed on 24 Sep. 2013, which is incorporated in its entirety by this reference. The perforation defines an extension of the fluid channel such that the extension of the fluid channel fluidly couples the deformable region and the fluid regulator 130. The moveable support member 125, which is bonded to the tactile layer, is situated within the perforation.

In one application in which the dynamic tactile interface is integrated or transiently arranged over a display and/or a touchscreen, the substrate 120 can be substantially transparent. For example, the substrate 120 can include a one or more layers of a glass, acrylic, polycarbonate, silicone, and/or other transparent material in which the fluid channel and fluid perforation are cast, molded, stamped, machined, or otherwise formed. Alternatively, the dynamic tactile interface can be arranged in a peripheral device without a display or remote from a display within a device. Thus, the substrate 120 can be substantially opaque. For example, the substrate 120 can include one or more layers of nylon, acetal, delrin, aluminum, steel, or other substantially opaque material.

In variations of the dynamic tactile interface in which the tactile layer 110 defines multiple deformable regions, the substrate 120 can also define multiple fluid channels and/or fluid perforations that fluidly couple to corresponding deformable regions to one or more displacement devices and/or valves. However, the substrate 120 can be manufactured in any other way and of any other material to fluidly couple the displacement device to the deformable region.

### 5. Fluid Regulator

The fluid regulator 130 of the dynamic tactile interface functions to control the volume and the pressure of fluid within a fluid circuit, which includes the fluid channel, the perforation, the fluid regulator 130, and/or the fluid reservoir, and to actuate flow of fluid into and out of the fluid channel from the fluid reservoir. Thus, the fluid regulator 130 can transition the deformable region (or facilitate transition of the deformable region) between the depressed setting and the expanded setting. The fluid regulator 130 can fluidly couple to the fluid channel. Alternatively, the fluid regulator 130 can fluidly couple directly to the perforation and, thus, indirectly fluidly couple to the fluid channel. The fluid regulator 130 can actively monitor and compensate for fluid volume and/or pressure changes in the fluid circuit in an active mode. Additionally or alternatively, fluid regulator 130 can passively adjust to fluid volume and/or pressure changes in the fluid circuit in a passive mode.

### 5.1 Fluid Regulator: Active Mode

In one implementation, the fluid regulator 130 can include a pump that is fluidly coupled to the fluid channel and the fluid reservoir, such that the pump can displace fluid from the fluid reservoir into the fluid channel and from the fluid channel into the reservoir. Alternatively, the pump can displace fluid from the fluid reservoir into the fluid channel and passively allow fluid to flow from the fluid channel into the fluid reservoir through a pressure sensitive valve. The pressure sensitive valve can maintain pressure within the fluid channel and the perforation. Additionally, when pressure in the fluid channel—and, therefore, pressure applied by the fluid on the valve—exceeds a threshold pressure, pressure applied by the fluid on the valve causes the valve to actuate open, thereby allowing fluid to pass through the valve. The pump can displace fluid in response to a trigger, such as a change in pressure within the fluid circuit (or the fluid channel) and/or a detected contact with the tactile surface. Thus, the pump can accommodate displacement of fluid from the fluid channel into the fluid reservoir when the deformable region transitions from the expanded setting to the depressed setting, thereby decreasing the volume of the fluid circuit and causing displacement of fluid from the fluid channel.

In an example of the preceding implementation, the fluid regulator 130 can include a pump that can be coupled to a touch-sensor coupled to the tactile layer 110 at the deformable region, the touch-sensor detecting contact with the tactile layer 110. The touch-sensor can be a capacitive, resistive, optical, infrared, acoustic pulse, etc. sensor. When a user contacts the deformable region, such as with a finger, the touch-sensor can trigger the pump to displace fluid from the fluid channel into the fluid reservoir, thereby transitioning the deformable region from the expanded setting into the depressed setting. Likewise, when the user removes contact from the deformable region (e.g., lifts the finger off of the tactile layer no), the touch-sensor can detect removal of contact and subsequently trigger the pump to displace fluid from the fluid reservoir into the fluid channel, thereby transitioning the deformable region from the depressed setting into the expanded setting.

In another example of the implementation, the fluid regulator 130 can include a pump that is coupled to a pressure sensor, which is also fluidly coupled fluid circuit. The pressure sensor can intermittently or constantly measure the pressure within the fluid channel. The pressure sensor can indicate to the pump a detected change in pressure within the fluid circuit from an initial pressure and accommodate for the detected change in fluid pressure by triggering the pump to displace fluid into or out of the fluid channel until the detected change in fluid pressure returns the initial pressure. Thus, when a user contacts the deformable region, such as with a finger, the pressure sensor can detect an increase in pressure corresponding to a decrease in volume due to deformation of the deformable region into the fluid channel. The pressure sensor can then trigger the pump to displace fluid from the fluid channel into the fluid reservoir, thereby allowing the user to transition the deformable region from the expanded setting into the depressed setting and maintaining the pressure within the fluid channel. Likewise, when the user removes contact from the deformable region (e.g., lifts the finger off of the tactile layer 110), the pressure sensor can detect a drop in pressure caused by removal of pressure applied to the deformable region. The pressure sensor can subsequently trigger the pump to displace fluid from the fluid reservoir into the fluid channel in order to increase pressure within the fluid channel, thereby transitioning the deformable region from the depressed setting into the expanded setting.

In another example, the fluid regulator 130 can include a pump that displaces fluid from the fluid channel, thereby transitioning the deformable region from a depressed setting to a substantially more depressed setting further into the perforation than the deformable region in the depressed setting. In this example, at an initial time, the pump can create a vacuum within the fluid channel. Thus, atmospheric pressure of air outside the fluid channel opposite the tactile layer depresses the deformable region into the perforation. A user can depress the deformable region further into the perforation. The pump can actively displace fluid from the fluid channel to a fluidly coupled reservoir to accommodate for decreased volume of the fluid channel due to depression of the deformable region. To transition the deformable region back to the depressed setting from the more depressed setting, the pump can displace fluid from the fluid reservoir into the fluid channel, thereby expanding the deformable region.

In the previous examples, the fluid regulator 130 can also include a valve, an elastic membrane 135, a piston, etc. coupled to a sensor that, when triggered, can be actuated to accommodate for changes in pressure and/or volume within the fluid channel.

### 5.2 Fluid Regulator: Passive Mode

In one implementation, the fluid regulator 130 can include a valve that opens when the pressure within the fluid channel exceeds a specified threshold and closes when the pressure within a fluidly coupled fluid reservoir, located opposite the valve from the fluid channel, exceeds a second specified threshold. For example, this implementation can employ a Zener diode-like valve, a gate valve, and/or any other pressure regulating valve that opens to allow fluid to flow across the valve when there is a pressure gradient across the valve and closes when the pressure gradient across the valve has been equilibrated.

### 6. Moveable Support Member

One variation of the dynamic tactile interface includes a moveable support member 125 arranged within the perforation and coupled to the deformable region. Generally, the moveable support member 125 can function to maintain a substantially rigid and flush surface of the tactile layer 110 at the deformable region in the expanded setting. The moveable support member 125 can be bonded to a surface of the tactile layer 110 opposite the tactile surface and at a location corresponding substantially to the deformable region and the perforation in the substrate 120. The moveable support member 125 can be bonded to the tactile layer no with an adhesive, such as epoxy (elastic or not), a weld, etc. Thus, as the moveable support member 125 moves, the tactile layer no moves with the moveable support member 125, and vice versa. Alternatively, the moveable support member 125 can be disconnected from the tactile layer no to define a free piston within the perforation. Thus, the moveable support member 125 can move independently of the tactile layer 110 and vice versa.

In one application in which the dynamic tactile interface is integrated or transiently arranged over a display and/or a touchscreen, the moveable support member 125 can be substantially transparent. For example, the substrate 120 can include one or more layers of a glass, acrylic, polycarbonate, silicone, and/or other transparent material in which the fluid channel and fluid perforation are cast, molded, stamped, machined, or otherwise formed. Alternatively, the dynamic tactile interface can be arranged in a peripheral device without a display or remote from a display within a device. Thus, the moveable support member 125 can be substantially opaque. For example, the substrate 120 can include one or more layers of nylon, acetal, delrin, aluminum, steel, or other substantially opaque material. The moveable support member can be of an index of refraction substantially similar to an index of refraction of the substrate. The movable support member may be constructed from a wide variety of materials using any applicable technique, and may include components integrated on the surface or within the substrate. For example, the movable support member may include an embedded electronic structure in the elastomer, or an embedded electronic structure may be used as one or more sensors in the substrate, or the movable support member may be optically clear or opaque.

In one implementation, the moveable support member 125 can include a rigid platen arranged within the perforation such that a cross-section of the platen substantially occupies a cross-section of the perforation. The platen can define shoulders (i.e., ledges) that cooperate with shoulders defined by the substrate 120 such that the shoulder defined by the substrate 120 substantially prevents an upper surface of the platen from moving above flush with a surface of the substrate 120 that is adjacent the tactile layer. In particular, a feature defined by the substrate can engage a shoulder or other feature defined by the support member 125 to retain the support member 125 within the perforation. Additionally, the shoulder of the platen can be defined such that when the shoulder of the platen engages the shoulder of the substrate 120, the upper surface of the platen is substantially flush with the surface of the substrate 120 adjacent the tactile layer.

However, the moveable support member 125 can be of any shape and size such that the moveable support member 125 substantially occupies the cross-section of the perforation and supports the tactile layer no in order to yield a substantially flush surface across the tactile layer in the expanded setting. For example, the vertical support member can have vertical sides that extend a vertical distance greater than the height of the fluid channel. When the vertical support member has vertical sides with a length greater than the height of the fluid channel, the sides of the vertical support member may extend above fluid channel and rest against a vertical side of the substrate when the vertical support member is in the depressed setting. In this position, the vertical side of the substrate may cooperate with the vertical side of the movable support member to prevent the movable support member from moving in a horizontal direction. When the tactile layer is in the expanded setting, the movable support member upper surface can be flush with the upper surface of the substrate, and the vertical sides of the movable support member will still be in cooperation with vertical sides of the substrate. Thus, the vertical walls of the substrate will prevent horizontal movement by the movable support member in both the depressed and expanded setting and the movable support member will only be allowed to travel in a vertical direction.

### 6.1 Moveable Support Member: Monostability

In one variation of the dynamic tactile interface shown in FIG. 3, the moveable support member 125 can exhibit monostability, wherein the moveable support member 125 defines a default position such that when no external pressure (e.g., depression of the tactile layer 110 by the user, fluid pressure, etc.) is applied to the moveable support member 125, the moveable support member 125 returns to the default position. The moveable support member 125 can define a default state wherein the moveable support member 125 supports the tactile layer no in either the depressed setting or the expanded setting.

In one implementation of the variation, the moveable support member 125 can define a default state of the moveable support member 125, wherein the moveable support member 125 supports the tactile layer no such that the default state of the deformable region is in the expanded setting. In this implementation, when the user applies pressure to the deformable region (e.g., presses the deformable region with a finger), the moveable support member 125 can translate into the perforation and/or into the fluid channel as the deformable region transitions into the depressed setting. However, when the user releases pressure applied to the deformable region (e.g., lifts the finger off of the tactile layer no), the moveable support member 125 returns to the default state, thereby returning the deformable region to the expanded setting.

In an example of the preceding implementation, the moveable support member 125 can include a spring or set of springs that couple(s) the shoulder of the moveable support member 125 to the shoulder of the substrate 120 near where the substrate 120 interfaces with the tactile layer no. The spring can be integrated (e.g., embedded) into the moveable support member 125. In this example, when the user applies pressure to the deformable region (e.g., presses the deformable region with a finger), the spring stretches from a natural length and elongates as the moveable support member 125 translates into the fluid channel. Pressure applied by the user on the moveable support member 125 applies a tensile force on the spring. The spring resists tensile elongation. Thus, when the user releases pressure applied to the deformable region (e.g., lifts the finger off of the tactile layer no), the spring returns to its original length, thereby returning the moveable support member 125 to the default position.

In a similar example, the moveable support member 125 can include a compression spring coupled to a lower surface of the moveable support member 125 (a surface opposite the tactile layer 110) and also coupled to the substrate 120 at a lower surface of the fluid channel corresponding to the perforation, the spring thereby coupling the moveable support member 125 to the substrate 120. A natural length of the compression spring can be calibrated to support the moveable support member 125 in the default position, wherein the moveable support member 125 supports the elastomer in the expanded setting. Thus, when the user applies pressure to the deformable region (e.g., presses the deformable region with a finger), the spring compresses from a natural length and shortens as the moveable support member 125 translates into the fluid channel. Pressure applied by the user on the moveable support member 125 applies a compressive force on the spring. The spring resists compressive shortening. Thus, when the user releases pressure applied to the deformable region (e.g., lifts the finger off of the tactile layer no), the spring returns to the natural length (i.e., expands), thereby returning the moveable support member 125 to the default position.

Though the springs, as shown in FIG. 3, may guide the movable support member in a vertical direction, other features or mechanisms may be used to prevent horizontal movement of the movable support member. For example, the vertical support member can have vertical sides that extend a vertical distance greater than the height of the fluid channel. When the vertical support member has vertical sides with a length greater than the height of the fluid channel, the sides of the vertical support member may extend above fluid channel and rest against a vertical side of the substrate when the vertical support member is in the depressed setting. In this position, the vertical side of the substrate may cooperate with the vertical side of the movable support member to prevent the movable support member from moving in a horizontal direction. When the tactile layer is in the expanded setting, the movable support member upper surface can be flush with the upper surface of the substrate, and the vertical sides of the movable support member will still be in cooperation with vertical sides of the substrate. Thus, the vertical walls of the substrate will prevent horizontal movement by the movable support member in both the depressed and expanded setting and the movable support member will only be allowed to travel in a vertical direction.

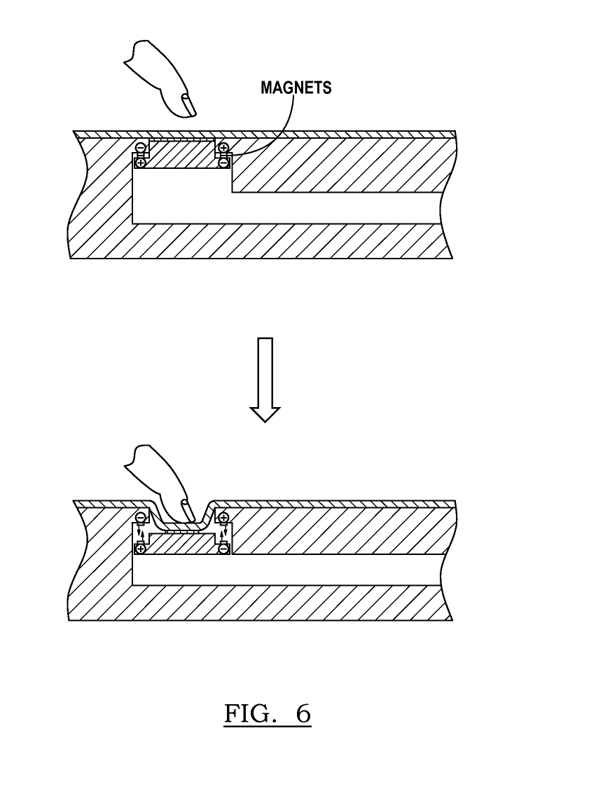

In another example shown in FIG. 6, the moveable support member 125 can include a magnet that magnetically couples the shoulder of the moveable support member 125 to a magnet with the opposite polarity coupled to the shoulder of the substrate 120. The magnet can be integrated (e.g., embedded) into the moveable support member 125 and the opposite polarity magnet can be integrated (e.g., embedded) into the shoulder of the substrate 120. Attractive magnetic forces between magnet and the polarly-opposite magnet cause the moveable support member 125 to rest in the default position, wherein the moveable support member 125 supports the tactile layer 110 in the expanded setting. In this example, when the user applies pressure to the deformable region (e.g., presses the deformable region with a finger), thereby overcoming the attractive magnetic forces between the magnet and the polarly-opposite magnet, the moveable support member 125 can translate into the fluid channel. The magnet and the polarly-opposite magnet can resist translation of the moveable support member 125 through attractive magnetic forces, which are weaker than pressure applied by the user on the deformable region and, therefore, the moveable support member 125. Thus, when the user releases pressure applied to the deformable region (e.g., lifts the finger off of the tactile layer 110), the attractive magnetic forces draw the magnets back together, thereby returning the moveable support member 125 to the default position.

As shown FIG. 6, the magnets can have different configurations and polarities. For example, the magnets may be placed further away from the cavity within the substrate. Thus, rather than placing the magnets directly in line with the outer edge of the movable support member, the one or more magnets placed in the substrate may be placed outside the vertical plane defined by the side of the cavity, such that the magnets in the substrate are horizontally offset from the magnets on or in the movable support member. Additionally, rather than placing the movable support member magnets directly under the corresponding magnets in the substrate, the movable support member magnets may include one or more magnets that are placed in or on a surface of the movable support member and horizontally offset from the one or more magnets on the surface or within the substrate. For example, one or more magnets may be placed on the bottom surface of the movable support member, such as directly in the middle of the movable support member outer surface. In another variation, the magnet polarizations may be matching polarizations rather than opposite polarizations. Further, the magnets may be placed at other locations, including in a ring formation along the surfaces or within the substrate and movable support member.

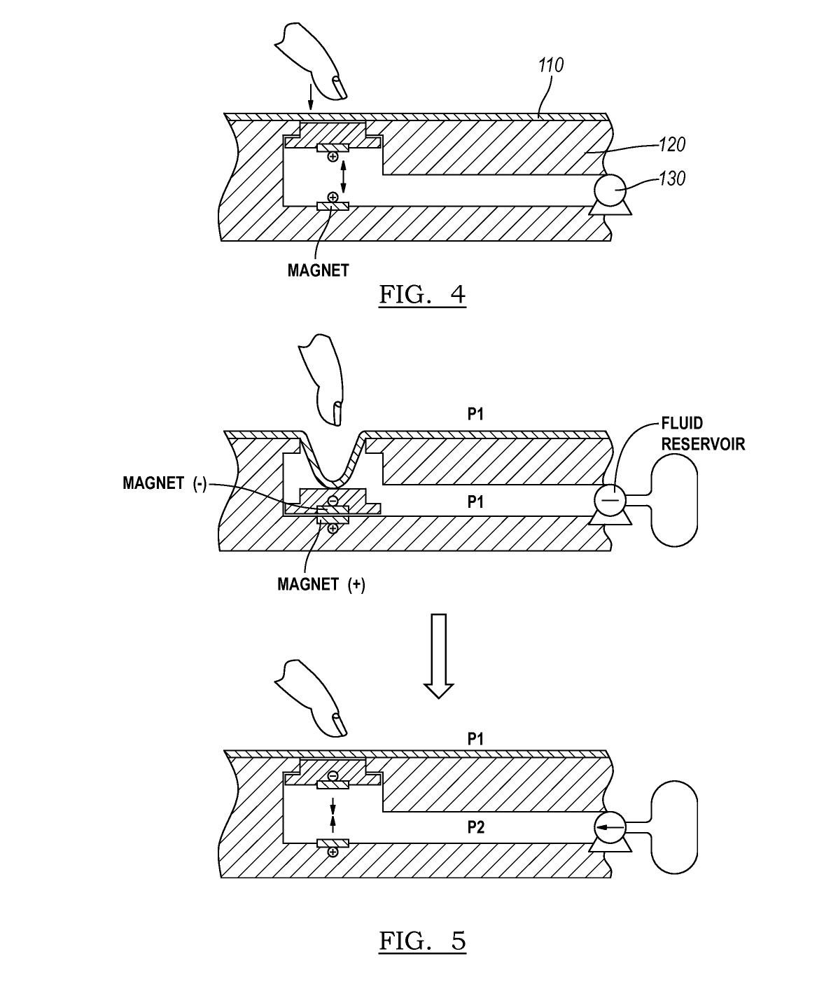

In a similar example shown in FIG. 4, the moveable support member 125 can include a magnet coupled to a lower surface of the moveable support member 125 (a surface opposite the tactile layer 110). The magnet magnetically couples to a pole of a magnetic dipole. The pole can be polarly-similar to the magnet and coupled to the substrate 120 at a lower surface of the fluid channel corresponding to the perforation. The magnet can be integrated (e.g., embedded) into the moveable support member 125 and the magnetic dipole can be integrated (e.g., embedded) into the substrate 120 at the lower surface of the fluid channel corresponding to the perforation. Repulsive magnetic forces between magnet and the polarly-similar pole cause the moveable support member 125 to rest in the default position with the shoulder of the moveable support member 125 contacting the shoulder of the substrate 120, the moveable support member 125 supporting the tactile layer no in the expanded setting. In this example, when the user applies pressure to the deformable region (e.g., presses the deformable region with a finger), thereby overcoming the repulsive magnetic forces between the magnet and the polarly-similar pole, the moveable support member 125 can translate into the fluid channel. The magnet and the polarly-similar pole can resist translation of the moveable support member 125 through repulsive magnetic forces, which are weaker than pressure applied by the user on the deformable region and, therefore, the moveable support member 125. Thus, when the user releases pressure applied to the deformable region (e.g., lifts the finger off of the tactile layer no), the repulsive magnetic forces push the magnets away from one another, thereby causing the moveable support member 125 to translate away from the polarly-similar dipole and returning the moveable support member 125 to the default position.

In another implementation, the moveable support member 125 can define the default position through sufficient fluid pressure applied by the fluid within the fluid channel to the lower surface of the moveable support member 125. The fluid regulator 130 can control the fluid pressure within the fluid channel and/or the fluid circuit such that the fluid pressure can support the moveable support member 125 and the deformable region in the default position. For example, fluid pressure within the fluid channel at an initial time can be substantially atmospheric. At the initial time, the moveable support member 125 and the deformable region can be substantially in the expanded setting. When the user applies pressure to the deformable region (e.g., by pressing the deformable region with a finger), a resultant decrease in volume within the fluid channel causes an increase in fluid pressure within the fluid channel. When the user releases pressure applied to the deformable region (e.g., lifts the finger off of the tactile layer no), a resulting pressure gradient across the tactile layer 110 between atmospheric air outside the fluid channel and the increased fluid pressure within the fluid channel drives tactile layer no and the moveable support member 125 to rise back through the perforation until the pressure gradient across the tactile layer 110 is equilibrated. The pressure gradient can be equilibrated when the moveable support member 125 returns to the default position and supports the tactile layer 110 in the expanded setting.

In a variation of the preceding implementation, in the expanded setting, the pump maintains fluid pressure within the fluid channel substantially above atmospheric pressure. By “over-pressurizing” the fluid channel, the moveable support member is forced upward into the perforation and engages the shoulder of the substrate. The shoulder in the substrate retains the moveable support member (i.e., to prevent the moveable support member from passing fully through the perforation), such that, in the expanded setting, the support member supports the deformable region substantially flush with an adjacent region of the tactile surface. In this variation, when the deformable region is in the expanded setting, the user must apply significant pressure to the deformable region to overcome the pressure within the fluid channel in order to depress the deformable region. A resultant decrease in volume within the fluid channel causes an increase in fluid pressure within the fluid channel. A pump coupled to the fluid channel can maintain fluid pressure within the fluid channel from the initial time as volume of the fluid channel decreases. To maintain the fluid pressure, the pump can displace fluid from the fluid channel into the fluid reservoir. Alternatively, the fluid channel can be sealed off from the displacement device (e.g., by a valve) so that fluid pressure within the fluid channel and the variable volume increases as the deformable region is depressed. When the user releases the deformable region (e.g., by lifting his finger off of the tactile layer 110), a pressure gradient across the tactile layer no between atmospheric air outside the fluid channel and the increased fluid pressure within the fluid channel drives the tactile layer no and the moveable support member 125 to rise back through the perforation until the pressure gradient across the tactile layer 110 is equilibrated. The fluid pressure can return to the initial fluid pressure when the moveable support member 125 returns to the default position and supports the tactile layer 110 in the expanded setting.

In an example of the variation, in the expanded setting, the pump maintains fluid pressure within the fluid channel substantially above atmospheric pressure. By “overpressurizing” the fluid channel, the fluid within the fluid channel substantially resists depression of the deformable region by a user. When an input at the deformable region is enabled, such as in response to an application initiated on the computing device, the pump releases fluid from the fluid channel to drop the fluid pressure therein to substantially near ambient air pressure, thereby enabling the deformable region to move downward into the perforation when depressed by a user. A touch-sensor coupled to the tactile layer can also detect when the user contacts and/or depresses the deformable region and the touch-sensor can transmit a signal to the pump to displace fluid from the fluid channel in order to draw and retain the deformable region into the depressed setting, thereby aiding transition of the deformable region. Similarly, a processor within the computing device can tactilely indicate a previous input selection and/or a configuration of the computing device by triggering the pump to draw fluid out of the fluid channel. Thus, the pump draws the deformable region downward into the depressed setting, such as after a user has contacted the deformable region, in order to indicate that the deformable region was selected. Alternatively, the pump draws the deformable region downward into the depressed setting in order to indicate that the deformable region does not correspond to a viable input.

As shown in FIGS. 4 and 6, a number of magnets arranged on and around the movable support member may guide the movable support member in a vertical direction. However, other features or mechanisms may be used to prevent horizontal movement of the movable support member. For example, the vertical support member can have vertical sides that extend a vertical distance greater than the height of the fluid channel. When the vertical support member has vertical sides with a length greater than the height of the fluid channel, the sides of the vertical support member may extend above fluid channel and rest against a vertical side of the substrate when the vertical support member is in the depressed setting. In this position, the vertical side of the substrate may cooperate with the vertical side of the movable support member to prevent the movable support member from moving in a horizontal direction. When the tactile layer is in the expanded setting, the movable support member upper surface can be flush with the upper surface of the substrate, and the vertical sides of the movable support member will still be in cooperation with vertical sides of the substrate. Thus, the vertical walls of the substrate will prevent horizontal movement by the movable support member in both the depressed and expanded setting and the movable support member will only be allowed to travel in a vertical direction.

In another implementation of the variation shown in FIG. 5, the moveable support member 125 can define a default state of the moveable support member 125, wherein the moveable support member 125 supports the tactile layer 110 such that the default state of the deformable region is in the depressed setting. In this implementation, a device, such as a spring, a magnet, etc., applies a force to the moveable support member 125, wherein the force is equilibrated at the default state. This implementation reduces force required to depress the deformable region from the expanded setting into the depressed setting. Fluid pressure maintained by the fluid regulator 130 can counteract the force applied by the device to the moveable support member in order to expand the deformable region from the depressed setting into the expanded setting. In one example of this implementation, the device (e.g., a spring) defines a natural (i.e., uncompressed) length such that the moveable support member 125 rests substantially within the fluid channel such that the tactile layer no is in the depressed setting when no external force is applied to the moveable support member 125 and pressure within the fluid channel is substantially atmospheric (P1). A pump coupled to the fluid channel increases pressure within the fluid channel (P2), thereby causing the fluid channel and, therefore, the deformable region to expand. The pump can be calibrated to increase pressure within the fluid channel until the deformable region and, therefore, the moveable support member 125 expanded to the expanded setting. When the user applies pressure to the deformable region in order to depress the deformable region from the expanded setting into the depressed setting, a touch sensor coupled to the pump can trigger the pump to shut off, thereby returning pressure within the fluid channel to atmospheric and the moveable support member 125 to the default state.

The moveable support member 125 can additionally or alternatively exhibit monostability in the depressed setting or the expanded setting by any other means suitable to the dynamic tactile interface. For example, the vertical support member can have vertical sides that extend a vertical distance greater than the height of the fluid channel. When the vertical support member has vertical sides with a length greater than the height of the fluid channel, the sides of the vertical support member may extend above fluid channel and rest against a vertical side of the substrate when the vertical support member is in the depressed setting. In this position, the vertical side of the substrate may cooperate with the vertical side of the movable support member to prevent the movable support member from moving in a horizontal direction. When the tactile layer is in the expanded setting, the movable support member upper surface can be flush with the upper surface of the substrate, and the vertical sides of the movable support member will still be in cooperation with vertical sides of the substrate. Thus, the vertical walls of the substrate will prevent horizontal movement by the movable support member in both the depressed and expanded setting and the movable support member will only be allowed to travel in a vertical direction.

### 6.2 Moveable Support Member: Bistability

In another variation of the dynamic tactile interface, the moveable support member 125 can exhibit bistability, wherein the moveable support member 125 defines two default positions such that when no external pressure (e.g., depression of the tactile layer 110 by the user) is applied to the moveable support member 125, the moveable support member 125 returns to one of two default position. A first default position of the moveable support member 125 can support the tactile layer no such that the deformable region is in the expanded setting. In a second default position, the moveable support member 125 can support the tactile layer no such that the deformable region is in the depressed setting. For example, the moveable support member 125 can be coupled to the shoulder of the substrate 120 with a bistable spring. The bistable spring can also couple the lower surface of the substrate 120 to the moveable support member 125. Alternatively, the moveable support member 125 can be magnetically coupled to the substrate 120 and to the lower surface of the fluid channel with a set of magnets. Multiple sets of magnets can stabilize the moveable support member 125 in the first default position and the second default position.

Additionally or alternatively, the moveable support member can couple to a haptic element that provides a click or other tactilely distinguishable indicator of movement of the moveable support member. The haptic element can function to mimic the mechanical feel of a mechanical snap button. Thus, the haptic element and the moveable support member can function as a haptic snap dome.

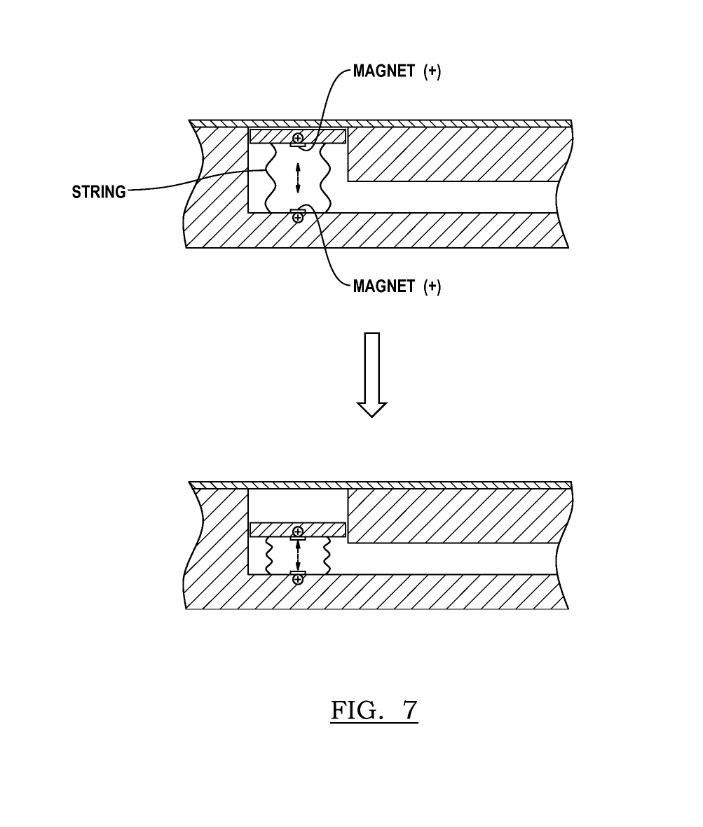

In another implementation shown in FIG. 7, the moveable support member can include strings coupled to the bottom of the fluid channel. The strings substantially prevent the moveable support member from moving to a position, wherein the moveable support member tactile layer is elevated above flush with the first region in the expanded setting.

### 6.3 Moveable Support Member: Press Down Buttons

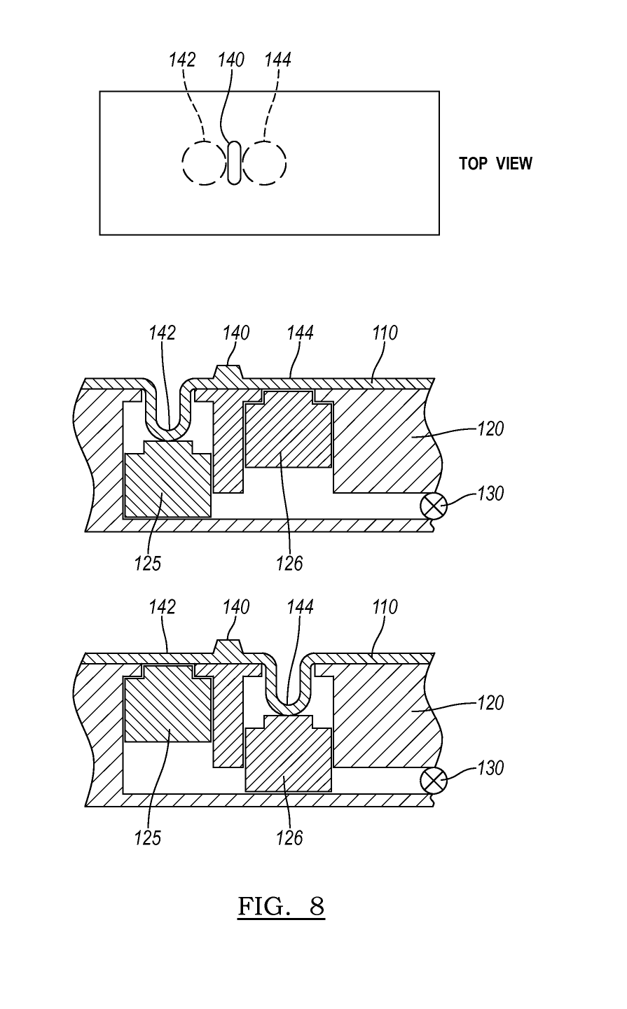

In another implementation, as shown in FIG. 8, the dynamic tactile interface may include one or more moveable support members that, when a perforated portion of the tactile layer above the particular movable support member is depressed, may travel downward into the substrate. The dynamic tactile interface includes: a substrate 120, a tactile layer 110, a fluid regulator 130, a first movable support member 125, and a second movable support member 126. The substrate 120 defines a fluid channel and a pair of perforations coupled to the fluid channel. The tactile layer 110 includes a first region, a first deformable region 142, and a second deformable region 144, the first region coupled to the substrate 120, and the deformable regions arranged over and coupled to the moveable support members 125 and 126, which are disconnected from the substrate 120, substantially correspond to the perforations, and are coupled to the fluid channel, the deformable regions operable between an expanded setting and a depressed setting, the deformable region substantially flush with the first region in the expanded setting and substantially below the first region (i.e., depressed toward the substrate 120) in the depressed setting. The fluid regulator 130 is fluidly coupled to the fluid channel and displaces fluid to and from the fluid channel in order to transition the deformable regions between the expanded setting and the depressed setting.

The dynamic tactile interface may also include a secondary guide 140 placed adjacent one or more deformable regions, such as for example between deformable regions 142 and 144. The secondary guide can define a tactilely distinguishable feature that indicates a peripheral location adjacent to a selectable deformable region on the tactile layer. In some implementations, one or more secondary guides can be placed on the tactile surface for different fingers or thumbs of a user, to provide the user with a more convenient tactile layer configuration for entering data through the tactile interface. The secondary guide can be placed adjacent to or near deformable regions to be selected, making a flush deformable region easier to detect by a user without looking at a rendered image provided by a display located beneath the dynamic tactile interface. The secondary guide can have a shape of thin bar and is located between two circular deformable regions. Thus, once a user finds secondary guide on the surface of the tactile layer, the user easily navigate to either side of the secondary guide to find deformable region 142 and/or deformable region 144. The secondary guide can be any shape, such as a circle, semi-circle, square, rectangle, closed shape, open shape, line or any other form. The secondary guide can also be implemented as a dynamic button implemented as a deformable region. For example, one or more deformable regions may form positive guides which are implemented on separate fluidic circuits from other deformable regions and are independently controllable. In some implementations, all secondary guides may be flat and flush at zero pressure. Once a positive pressure is applied to secondary guides, the secondary guides may transition to an expanded state and rise to a position above the surface of the tactile layer, indicating to the user the location and readiness of the depressible buttons. The depressible secondary guide buttons can, in some implementations, be harder to push down due to the positive pressure, but still at a low enough pressure to be depressible.

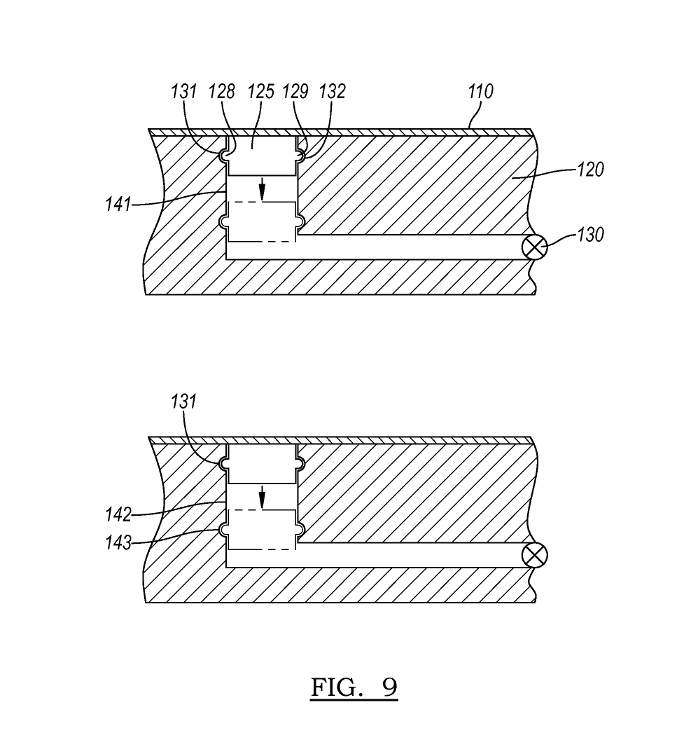

When either of deformable regions 142 and 144 are pressed down, causing the corresponding movable support member 125 or 126 to travel downward within the substrate into the depressed setting, the depressed deformable region may hold its concave depressed position for a period of time after the force applied to the deformable region is withdrawn. Each movable support member may stay in place due to friction between the substrate wall and movable support member wall, one or more nubs in the moveable support member and corresponding cavities (or “anti-nubs”) in the substrate wall that engage to keep the movable support member in a particular position within the substrate (see FIG. 9), or some other mechanism that maintains the depressed deformable region in a depressed state. In an implementation, when one of the two movable support members 125 and 126 is currently in the depressed setting, applying a force to the deformable region associated with the other movable support member can act to force the other deformable region to the expanded setting. Thus, for example, if a first force has been applied to deformable region 142 which places the deformable region and corresponding movable support member 125 into a depressed setting, a second force may be applied to the deformable region 144 to transition the region 144 and movable support member 125 into the depressed setting and automatically transitioning the deformable region and movable support member previously in the depressed setting to an expanded setting. The automatic transition from the depressed setting to the expanded setting can be caused passively by an increased pressure in the fluid channel caused by the depression of the second deformable region, such that the fluidic pressure causes the deformable region previously in the depressed state to transition to an expanded state, wherein the upper surface of the first movable support member would be flush with the substrate. The automatic transition from the depressed setting to the expanded setting can also be caused actively by a fluid pump that increases the pressure of fluid in the fluid channel upon detecting a force at the second deformable region, such that the fluidic pressure increase provided by the fluid pump causes the first deformable region previously in the depressed state to transition to an expanded state. In some implementations, a third button or depressible region may be used to release either or both of the first deformable region and second deformable region from a depressed state to an expanded state, allowing each or both of the depressible regions to transition from the depressed state to the expanded state in response to receiving a force at the third button or depressible region. In any case, the feature of having a deformable region remain in the depressed state until another deformable region, such as a deformable region adjacent to the first deformable region such as for example on the opposite side of a secondary guide, may be useful in several applications such as an automotive interface. In this implementation, a user may find the two or more deformable regions using the secondary guide, and may press down on either deformable region, wherein each region may correlate to an automotive feature or control, such as a radio, temperature control, door locks, or other feature. In some implementations, a first depressed deformable region (or button) may not necessarily always be dependent on the second deformable region or any other deformable region (i.e., button) being depressed in order to return to an expanded setting. For example, the depressed deformable region may simply stay depressed until an external command indicates it is time to expand (and any other buttons that were depressed) back to a position that is flush with the tactile layer. Additionally, depressing a deformable region in a retracted state (e.g., depressing a depressed button on the tactile layer) may enable it to be released. This may be implemented using a cams, guide pins, and springs similar to a “click” pen or other suitable mechanisms.

In some implementations, the movable support members may be part of a pivoting mechanism. For example, the dynamic tactile interface can include a pivot coupled to the substrate and arranged in the fluid conduit. The pivot can rotate between a first configuration and a second configuration. Furthermore, the pivot can be coupled to an electromechanical motor configured to rotate the pivot in response to a detected input at the deformable region, removal of the input from the deformable region, or any other trigger event detected by a sensor coupled to the tactile layer or a pressure sensor fluidly coupled to the fluid channel. For example, the pivot can rotate with pulses of fluid directed at a surface of a first magnet, wherein the first magnet can rotate about the pivot. The displacement device or a second displacement device (e.g., a pump) can pulse fluid in the direction of the surface of the first magnet. The pivot can support the first magnet with a first pole of the first magnet adjacent a second magnet to attract the second magnet in a first configuration and support the first magnetic with a second pole of the magnet adjacent the second magnet to repel the second magnet in a second configuration, the pivot rotating between the first configuration and the second configuration in response to a detected input on the tactile layer. The pivot can rotate to the first configuration in response to a first detected input at the deformable region (e.g., depression of the deformable region in the expanded setting toward the substrate no) and rotates to the second configuration in response to a second detected input at the deformable region (e.g., a second depression of the deformable region in the retracted setting toward the substrate). Thus, the dynamic tactile interface can function to define a toggle switch at the deformable region.

In another implementation, a second electromagnetic element can be coupled to the tactile layer at the deformable region and can be magnetically attracted to the first electromagnetic element in a first setting and magnetically repelling the first electromagnetic element in a second setting, the first electromagnetic element and the second electromagnetic element cooperating to displace the deformable region from the expanded setting toward the substrate at a nonlinear displacement rate in response to depression of the deformable region in the expanded setting toward the substrate. The first electromagnetic element and the second electromagnetic element can cooperate to displace the deformable region (i.e., with or without a displacement device) from the expanded setting toward the substrate in the first configuration at a nonlinear displacement rate in response to depression of the deformable region in the expanded setting toward the substrate. In this implementation, the dynamic tactile interface can also include a sensor outputting a first signal corresponding to depression of the deformable region toward the substrate and a second signal corresponding to a trigger event, and a processor electrically coupled to the second electromagnetic element and controlling the second electromagnetic element, the processor configuring the first setting in response to the first signal and configuring the second setting in response to the second signal. The trigger event can include a second input to the deformable region. Thus, the deformable region can function as a toggle switch. Alternatively, the trigger event can include removal of an input from the deformable region. Details for a deformable region functioning as a toggle switch are discussed in more detail in U.S. patent application Ser. No. 14/591,807, the entire content of which is incorporated herein by reference.

In some instances, the dynamic tactile layer may control whether the deformable region is flat or not and can provide a pressure to maintain the movable support member at a position flush with the substrate. The pressure may be modified when a force associated with a user (or initiated by a user, such as for example from a stylus) pressing down on the deformable region is detected. When a deformable region receives a force from a user, the dynamic tactile layer can provide an opposite force towards the user when he or she applies force onto the particular region to provide input. This feedback force may be the result of Newton's third law, whenever a first body (the user's finger or other object controlled by the user) exerts a force on a second body (the deformable region), the second body exerts an equal and opposite force on the first body, or, in other words, a passive tactile response. Alternatively, the displacement device 130 may retract the cavity 125 to deform the particular region 113 inward. However, any other suitable method of deforming a particular region 113 of the tactile interface layer 100 may be used.

In some implementations, the displacement device may maintain and transition between one of multiple fluid pressure levels within the cavity. For example, the displacement device may set a first pressure that prevents the movable support member from being depressed even when an external force is received from a user, stylus or other element on the deformable region. The displacement device may set a second pressure in the cavity that keeps the movable support member in place when no force is present but allows the movable support member to be depressed inward when a pressure is received on the deformable region associated with the movable support member. The displacement device may also set a pressure level that causes the movable support layer to retract inward into the cavity without any additional force (e.g., create a zero or negative fluid pressure in the cavity).

The tactile interface layer 100 preferably includes a sensor that functions to detect the force applied to the particular deformed region by the user. The force may be a force that substantially inwardly deforms the deformed particular region of the surface, but may alternatively be a force that does not substantially inwardly deform the deformed particular region. However, any other suitable type of force may be detected. For example, in the variation of the tactile layer as described above, the sensor may be a pressure sensor that functions to detect the increased pressure within the fluid channel that results from an inward deformation of the deformable region. In some implementations, the displacement of the deformed region may be detected by one or more sensors. The sensors may be placed on the tactile layer, on or in the substrate, or elsewhere in the dynamic tactile interface to detect when the deformable region has changed from shape or position. Alternatively, a capacitive sensor may be used to detect the presence of a finger or stylus on the deformable region. In this variation, the presence of a force is deduced from the detected presence of the finger of the user. Alternatively, the sensor may be a sensor included in the device to which the tactile interface layer is applied to, for example, the device may include a touch sensitive display onto which the tactile interface layer is overlaid. The force of the user may be detected using the sensing capabilities of the touch sensitive display. However, any other suitable force detection may be used.

Similarly, the tactile interface layer 100 preferably includes a processor that functions to interpret the detected gesture as a command. The processor may include a storage device that functions to store a plurality of force types (for example, the magnitude of the force or the duration of the applied force) and command associations and/or user preferences for interpretations of the force as commands. The processor may be any suitable type of processor and the storage device may be any suitable type of storage device, for example, a flash memory device, a hard drive, or any other suitable type. The processor and/or storage device may alternatively be a processor and/or storage device included into the device that the tactile interface layer 100 is applied to. However, any other suitable arrangement of the processor and/or storage device may be used.

In an implementation, the dynamic tactile layer can include a mechanism for providing tactile feedback when an input such as a downward force to the deformable region is received. In this implementation, the downward force may be detected by a capacitive touch sensor, fluidic pressure sensor, or other mechanism. Once the force is detected, and optionally determined to be a user initiated input, a vibration or other tactile response can be generated to inform the user that the input is received at a particular deformable region on the tactile interface. In some implementations, the tactile response such as a vibration may indicate a state of a device upon which the dynamic tactile interface is placed, such as a state of a computing system that receives input through the dynamic tactile interface. The tactile feedback, such as a vibration, may be provided by a processor that controls a vibrating member or system and causes a vibration in response to detecting the input of force applied at one or more deformable regions. For example, for electromagnets or other elements, the physical motion of the button itself can produce a vibration, change in air density—which can reduce the effective coefficient of friction (as can similarly be produced with ultrasonic waves)—, or other effect that causes tacit feedback when depressing a deformable region.

In a further variation, the movable support member can be positioned such that the upper surface does not extend above the upper surface of the substrate through use of nubs and anti-nubs. FIG. 9 illustrates an implementation of the dynamic tactile interface in which the movable support member is prevented from moving above a certain point by the use of nubs and anti-nubs. The dynamic tactile interface of FIG. 9 includes tactile layer 110, substrate layer 120, movable support member 125, and fluid regulator 130. Movable support member 125 may travel vertically within a cavity created by substrate 120. The movable support member may include one or more nubs 128 and 129 on the outer surface of the member. The nubs may extend outward from the surface of the movable support member and may have a shape that cooperates with the space of one or more anti-nubs 131 and 132 located on the vertical walls of the cavity. Nubs 128 and 129 may engage the anti-nubs 131 and 132 when the nubs and anti-nubs are at the same vertical position. The anti-nubs may be positioned such that when the nubs are positioned to extend into the anti-nubs, the upper surface of the movable support member 125 is flush with the upper surface of the substrate 120.

In an implementation, the nubs and anti-nubs can provide a latching feature. The latching feature is preferably a mechanical construction within the movable support member and/or the substrate that provides tactile feedback, such as in the form of a “click,” when the deformable region is depressed. In one example implementation, a wall of the cavity includes a ridge and the movable support member nub is in the form of a lip such that at least one of the lip and the ridge deform as the movable support member is forced into the cavity, wherein deformation of the lip and/or ridge results in a “click.” In this example implementation, the geometry of the lip and ridge can latch the position of the movable support member until a second force is applied, such as by changing fluid pressure within the cavity (e.g., with the displacement device) or by depressing the deformable region to move the movable support member further into the cavity. In another example implementation, the cavity includes a ridge and the movable support member includes a lip such that at least one of the lip and the ridge deform as the deformable region is depressed into the cavity, wherein deformation of the lip and/or ridge results in a “click.” In this example implementation, the ridge of the cavity is coupled to a bladder or second cavity, wherein displacement of fluid into or out of (or increase or decrease is fluid pressure in) the bladder or second cavity moves the lip into and out of the cavity, respectively, to adjust interference between the lip and the ridge. Generally, in this example implementation, the ridge can be moved toward the lip to yield a firmer click, and the ridge can be moved away from the lip to yield a softer click or to unlatch the movable support member. In this example implementation, the cavity can include one or more ridges coupled to one or more bladders or second cavities, and the one or more bladders or second cavities can be coupled to the fluid regulator 130, can be coupled to an independent displacement device, and/or can be controlled by any number of valves. In yet another example implementation, the movable support member includes a piston that engages a cylinder in the cavity. The movable support member further includes a lip and the cavity further includes a ridge, as described above. In this example implementation, the cavity and cylinder are filled with the fluid, and as the movable support member is depressed from a first position to a second position, fluid is trapped in the cylinder and compressed by the piston. Once released, the movable support member returns to the first position as the compressed fluid in the cylinder acts as a return spring. Because the lip and/or ridge preferably deform to generate a “click” when the movable support member is depressed from the first position to the second position, and because the lip and/or ridge preferably deform to generate a second “click” when the movable support member returns to the first position, the example implementation can yield tactile feedback that is a double click. Furthermore, the piston and cylinder of this example implementation can also be applied to any of the foregoing example implementations or variations. However, the tactile layer no, substrate 120, and/or any other elements of the preferred system can include any other feature.

In some implementations, the cavity formed by the substrate can have different widths at different positions, allowing for easier travel of the movable support member at different points within the cavity. For example, as shown in FIG. 9, a portion of the cavity wall 142 may have a larger circumference and width than portions of the cavity wall above anti-nub 131 and below anti-nub 143. The larger cavity wall circumference may allow movable support member 125 to travel vertically within the cavity with less friction, based on the nubs pressed against the cavity wall, in the space along cavity wall portion 142 than other portions of the cavity wall. In movable support member 125 may click into place in one or more positions associated with anti-nubs located within the cavity, but may only travel vertically along the portion of the wall that was wider (e.g., a larger circumference or travel area) and provided for less friction between the nubs 128 and 129 and the cavity walls.

As a person skilled in the art will recognize from the previous detailed description and from the figures and the claims, modifications and changes can be made in the foregoing embodiments of the invention without departing from the scope of this invention as defined in the following claims.

I claim:

1. A dynamic tactile interface, comprising:
a substrate comprising an attachment surface, the substrate partially defining a cavity adjacent the attachment surface and defining a fluid channel fluidly coupled to the cavity;
a tactile layer comprising a deformable region and an undeformable region, the undeformable region coupled to the attachment surface, the deformable region disconnected from the substrate, the tactile layer defining an outer tactile surface opposite the substrate; and
a movable support member within the cavity and below the deformable region, the movable support member configured to travel within the cavity, an upper surface of the movable support member being flush with an upper surface of the substrate when the deformable region is an expanded setting, the upper surface of the movable support member being offset below the upper surface of the substrate when the deformable region is an depressed setting, a portion of the deformable region extending into the cavity in the depressed setting.

2. The dynamic tactile interface of claim 1, further including a sensor that detects an input on the deformable region.

3. The dynamic tactile interface of claim 2, wherein the sensor is a touch sensor that detects a force received on the deformable region.

4. The dynamic tactile interface of claim 2, wherein the sensor is a pressure sensor that detects an increase in pressure within the fluid channel.

5. The dynamic tactile interface of claim 2, wherein the sensor detects the displacement of a deformable region.

6. The dynamic tactile interface of claim 2, wherein a height of an opening of the fluid channel is less than a height of a surface of the movable support member that faces the opening of the fluid channel.

7. The dynamic tactile interface of claim 1, wherein the movable support member includes a shoulder and substrate includes a shoulder, the movable support member shoulder and substrate shoulder matching to make the upper surface of the movable support member and the upper surface of the substrate flush.

8. The dynamic tactile interface of claim 1, herein the movable support member includes a nub and substrate includes an anti-nub, the movable support member nub and substrate anti-nub matching to make the upper surface of the movable support member and the upper surface of the substrate flush when the anti-nub receives the nub.

9. The dynamic tactile interface of claim 8, wherein the substrate includes a plurality of sets of anti-nubs to receive the movable support member nubs, each set of anti-nubs associated with a different position within the cavity.

10. The dynamic tactile interface of claim 1, further comprising a plurality of elements that provide an attractive or repelling force between the moveable support member and the substrate.

11. The dynamic tactile interface of claim 10, further comprising a plurality of magnets, the plurality of magnets applying a force on the movable support member.

12. The dynamic tactile interface of claim 10, wherein the plurality of magnets are configured to provide an attractive force on the movable support member, the movable support member including at least one magnet.

13. The dynamic tactile interface of claim 10, wherein the plurality of magnets are configured to provide a repulsive force on the movable support member, the movable support member including at least one magnet.

14. The dynamic tactile interface of claim 1, further comprising a spring, the spring applying a force on the movable support member.

15. The dynamic tactile interface of claim 14, wherein the force applied by the spring acts to pull the movable support member towards the depressed setting.

16. The dynamic tactile interface of claim 14, wherein the force applied by the spring acts to push the movable support member towards the depressed setting.

17. The dynamic tactile interface of claim 1, further comprising a secondary guide located adjacent on the tactile layer and adjacent to the deformable region.

18. The dynamic tactile interface of claim 17, wherein the secondary guide is coupled to a second fluid channel formed by the substrate, wherein fluid from the fluid channel may expand the secondary guide to rise outward from the surface of the tactile layer.

19. The dynamic tactile interface of claim 1, further comprising:
a second cavity partially defined by the substrate and coupled to the fluid channel;
a second deformable region disconnected from the substrate; and
a second movable support member within the second cavity and below the second deformable region, wherein receiving an input force to transition the second deformable region from the expanded setting to the depressed setting automatically transitions the first deformable region that was previously in a depressed setting to the expanded setting.

20. The dynamic tactile interface of claim 1, further comprising a displacement device, the displacement device configured to displace fluid through the fluid channel and into the cavity to transition the deformable region between the retracted setting and the expanded setting;

21. The dynamic tactile interface of claim 17, wherein the displacement device is configured to displace fluid in response to a signal received from a sensor.

22. The dynamic tactile interface of claim 20, the displacement device providing a pressure of fluid in the fluid channel and cavity that prevents the movable support member from being depressed when a pressure is applied to the movable support member by an external force.

23. The dynamic tactile interface of claim 20, the displacement device providing a pressure of fluid in the fluid channel and cavity that allows the movable support member to be depressed when a pressure is applied to the movable support member by an external force.

24. The dynamic tactile interface of claim 20, the displacement device providing a pressure of fluid in the fluid channel and cavity that causes the movable support member to move into the cavity without receiving an external force.

25. The dynamic tactile interface of claim 1, further comprising a processor, the processor interpreting a detected gesture received at the deformable region as a command.
